(19) United States
(12) Patent Application Publication
(10) Pub. No.: US 2025/0188631 A1
(43) Pub. Date: Jun. 12, 2025

(54) IRIDIUM-NICKEL CATALYST FOR ELECTROCHEMICAL CELL, PREPARATION METHOD THEREOF AND MEMBRANE ELECTRODE ASSEMBLY USING THE SAME

(71) Applicants: Hyundai Motor Company, Seoul (KR); Kia Corporation, Seoul (KR); Korea Advanced Institute of Science and Technology, Daejeon (KR)

(72) Inventors: Daeyong Son, Seoul (KR); Jongkil Oh, Yongin-si (KR); Hyun Joo Lee, Daejeon (KR); Sun Seo Jeon, Daejeon (KR); Hye Seong Jeon, Daejeon (KR)

(21) Appl. No.: 18/612,059

(22) Filed: Mar. 21, 2024

(30) Foreign Application Priority Data
Dec. 7, 2023 (KR) 10-2023-0176160

(51) Int. Cl. C25B 11/091; C25B 1/04; C25B 9/23

(52) U.S. Cl. CPC C25B 11/091; C25B 9/23; C25B 1/04

(57) ABSTRACT

An embodiment water electrolysis catalyst includes iridium oxide including a rutile phase and iridium-nickel oxide including a hexagonal phase. An embodiment method of preparing a water electrolysis catalyst includes preparing a mixture including an iridium precursor, a nickel precursor, and cysteamine hydrochloride, drying the mixture, grinding the dried mixture, and firing a ground product, wherein the water electrolysis catalyst includes iridium oxide including a rutile phase and iridium-nickel oxide including a hexagonal phase.

### CROSS-REFERENCE TO RELATED APPLICATIONS

This application claims the benefit of Korean Patent Application No. 10-2023-0176160, filed on Dec. 7, 2023, which application is hereby incorporated herein by reference.

### TECHNICAL FIELD

The present disclosure relates to a catalyst including iridium oxide including the rutile phase and iridium-nickel oxide including the hexagonal phase, a preparation method thereof, and a membrane electrode assembly using the same.

### BACKGROUND

Hydrogen energy has recently been in the spotlight as an energy source that may replace existing fossil fuels. Hydrogen energy may be easily obtained by electrolyzing water and is eco-friendly because water is produced upon combustion of hydrogen.

There are several types of water electrolysis, and thereamong, a membrane electrode assembly (MEA) using an exchange membrane is attracting attention due to its high efficiency. Cation exchange membrane water electrolysis is a reaction that decomposes water into hydrogen and oxygen using electrical energy and has an advantage of quickly converting electrical energy into chemical energy. In the case of new renewable energy, it is difficult to fully utilize new renewable energy because the amount of power generation is not maintained consistently depending on the environment and conditions, and therefore, if the surplus new renewable energy is converted into hydrogen, i.e., chemical energy, through cation exchange membrane water electrolysis and is then stored, new renewable energy having the inconsistent amount of power generation may be fully utilized.

Cation exchange membrane water electrolysis has an advantage of being able to produce hydrogen with high efficiency and purity. In water electrolysis, hydrogen generation and oxygen generation reactions occur simultaneously, and a catalyst is essential for each reaction to occur efficiently. However, when a cation exchange membrane is used, a large overvoltage is applied to an oxidation electrode, and since an ionomer is a strongly acidic material, most catalysts may not maintain their performance and suffer from deterioration and oxidation problems.

Currently, iridium (Ir) is well known as a material with good performance and durability in the oxygen generation reaction in cation exchange membrane water electrolysis. However, iridium is a precious metal with extremely small reserves and a very small mining output, and thus poses quantitative and financial limitations to building a large-scale water electrolysis system. Conventionally, in order to reduce hydrogen production costs through development of catalysts, a method of saving electrical energy usage using a highly active catalyst and a method of extending a catalyst replacement period using a highly durable catalyst have been proposed, and in addition, since iridium which is a precious metal is very expensive, a measure to reduce iridium usage has been studied.

As various iridium-based catalysts are studied, the importance of structural and environmental factors of iridium, which acts as the active site of a catalyst, is being mentioned. Particularly, the importance of structural connectivity, symmetry, and the nature of oxygen ligands in catalyst activity or stability has emerged, and research on molten salt synthesis has been conducted, but there is no research on iridium catalysts including nickel (Ni).

The above information disclosed in this background section is only for enhancement of understanding of the background of the invention, and therefore it may contain information that does not form the prior art that is already publicly known.

### SUMMARY

Embodiments of the present disclosure can solve problems associated with the prior art, and an embodiment of the present disclosure provides a water electrolysis catalyst including iridium-nickel oxide which has reduced iridium usage by adding nickel and has higher activity and durability than conventionally reported iridium catalysts.

Another embodiment of the present disclosure provides a preparation method of a water electrolysis catalyst including iridium-nickel oxide using an iridium precursor, a nickel precursor, and cysteamine hydrochloride.

Yet another embodiment of the present disclosure provides a membrane electrode assembly (MEA) including a water electrolysis catalyst.

The embodiments of the present disclosure are not limited to the above-mentioned embodiments. The embodiments of the present disclosure will become clearer from the following description and may be realized by means stated in the claims and combinations thereof.

One embodiment of the present disclosure provides a water electrolysis catalyst including iridium oxide including a rutile phase and iridium-nickel oxide including a hexagonal phase.

In a preferred embodiment, the iridium oxide may include a peak for at least one of the (110), (101), (200), and (211) crystal plane, when analyzed by X-ray diffraction (XRD).

In another preferred embodiment, the iridium-nickel oxide may include a peak for at least one diffraction angle 2θ of 18° to 20°, 33.0° to 34.5°, 35.0° to 37.0°, and 46° to 48°, when analyzed by X-ray diffraction (XRD).

In still another preferred embodiment, the iridium oxide may have a nanoneedle-shaped structure, and the iridium-nickel oxide may have a hexagonal platelet-shaped structure.

In yet another preferred embodiment, the iridium oxide having the nanoneedle-shaped structure may be located on or physically attached to at least a portion of a surface of the iridium-nickel oxide having the hexagonal platelet-shaped structure.

Another embodiment of the present disclosure provides a preparation method of a water electrolysis catalyst including preparing a mixture including an iridium precursor, a nickel precursor, and cysteamine hydrochloride, drying the mixture, grinding the dried mixture, and firing a ground product.

In a preferred embodiment, the iridium precursor may include at least one selected from the group consisting of iridium chloride (IrCl₃), iridium chloride hydrate (IrCl₃·xH₂O), potassium hexachloroiridate (K₂IrCl₆), potassium hexachloroiridate hydrate (K₂IrCl₆·xH₂O), and combinations thereof.

In another preferred embodiment, the nickel precursor may include at least one selected from the group consisting of nickel sulfate, nickel chloride, nickel bromide, nickel acetylacetonate, nickel cyclohexanebutyrate, nickel ethylhexanoate, nickel octanoate, and combinations thereof.

In still another preferred embodiment, the iridium precursor and the nickel precursor may be configured such that a number of moles of iridium is greater than a number of moles of nickel.

In yet another preferred embodiment, the iridium precursor and the nickel precursor may be configured such that a molar ratio of iridium:nickel is 1.1:1 to 3:1.

In still yet another preferred embodiment, preparing the mixture may be performed in an aqueous solution including sodium nitrate (NaNO₃).

In a further preferred embodiment, firing the ground product may be performed at a temperature of 450° C. to 650° C.

In another further preferred embodiment, in firing the ground product, a temperature of the ground product may be raised to a target temperature of 450° C. to 650° C. at a heating rate of 10° C./min, and may then maintain the target temperature for 30 minutes to 2 hours.

Yet another embodiment of the present disclosure provides a membrane electrode assembly including a cathode, an anode, and an electrolyte membrane interposed between the cathode and the anode.

Other aspects and preferred embodiments of the invention are discussed infra.

The above and other features of embodiments of the invention are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows X-ray diffraction analysis results of catalysts prepared according to one Preparation Example of embodiments of the present disclosure;

FIG. 2 shows an image of the appearance of a catalyst in Control Group observed with a transmission electron microscope according to one Test Example of embodiments of the present disclosure;

FIG. 3 shows an image of the appearance of a catalyst in Comparative Example 2 observed with the transmission electron microscope according to one Test Example of embodiments of the present disclosure;

FIG. 4 shows an image of the appearance of a catalyst in Example 1 observed with the transmission electron microscope according to one Test Example of embodiments of the present disclosure;

FIG. 5 shows an image of the appearance of a catalyst in Comparative Example 3 observed with the transmission electron microscope according to one Test Example of embodiments of the present disclosure;

FIG. 6 shows evaluation results of activities of the catalysts in a three-electrode system according to one Test Example of embodiments of the present disclosure;

FIG. 7 shows evaluation results of performances of the catalysts in membrane electrode assemblies according to one Test Example of embodiments of the present disclosure; and

FIG. 8 shows evaluation results of durabilities of the catalysts in the membrane electrode assemblies according to one Test Example of embodiments of the present disclosure.

It should be understood that the appended drawings are not necessarily to scale, presenting a somewhat simplified representation of various preferred features illustrative of the basic principles of embodiments of the invention. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION OF ILLUSTRATIVE EMBODIMENTS

The above-described objects, other objects, advantages, and features of embodiments of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the accompanying drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising”, and “having”, are to be interpreted as indicating the presence of characteristics, numbers, steps, operations, elements, or parts stated in the description or combinations thereof, and they do not exclude the presence of one or more other characteristics, numbers, steps, operations, elements, parts, or combinations thereof, or the possibility of adding the same. In addition, it will be understood that when a part, such as a layer, a film, a region, or a plate, is said to be “on” another part, the part may be located “directly on” the other part or other parts may be interposed between the two parts. In the same manner, it will be understood that when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected, and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9, and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

One embodiment of the present disclosure relates to a water electrolysis catalyst including iridium oxide including the rutile phase and iridium-nickel oxide including the hexagonal phase.

In embodiments of the present disclosure, the iridium oxide may include the rutile phase and may be expressed by the chemical formula [IrOₓ]. Here, x may be a value that makes iridium oxide (IrOₓ) electrically neutral.

In the specification, the term “rutile phase” is one of the crystal structures of nanoparticles and may indicate a two-dimensional layer structure observed in titanium oxide (TO₂) and the like. The rutile phase may have an oval-shaped crystal structure with different aspect ratios, and the macroscopic shape of particles in the rutile phase may be a long and thin nanoneedle shape.

In embodiments of the present disclosure, the iridium oxide may include a peak for at least one of the (110), (101), (200), and (211) crystal plane, when analyzed by X-ray diffraction (XRD).

In embodiments of the present disclosure, the iridium-nickel oxide may include the hexagonal phase and may be expressed by the chemical formula [Ir₂NiOₓ]. Here, x may be a value that makes iridium-nickel oxide (Ir₂NiOₓ) electrically neutral.

In the specification, the term “hexagonal phase” is one of the crystal structures of nanoparticles, and, unlike the rutile phase, may indicate a hexagonal crystal structure. The macroscopic shape of particles in the hexagonal phase may be a hexagonal platelet shape.

In embodiments of the present disclosure, the iridium-nickel oxide may include a peak for at least one diffraction angle 2θ of 18° to 20°, 33.0° to 34.5°, 35.0° to 37.0°, and 46° to 48°, when analyzed by X-ray diffraction (XRD).

In one embodiment, the iridium-nickel oxide may include peaks at diffraction angles 2θ of about 19.0°, about 33.7°, about 35.8°, and about 47°, when analyzed by X-ray diffraction (XRD).

In embodiments of the present disclosure, the iridium-nickel oxide may be characterized in that iridium atoms and nickel atoms form a hexagonal close-packed (HCP) crystal structure.

In embodiments of the present disclosure, the iridium oxide may microscopically have the rutile phase and may macroscopically have particles having a nanoneedle-shaped structure.

In embodiments of the present disclosure, the iridium-nickel oxide may microscopically have the hexagonal phase and may macroscopically have particles having a hexagonal platelet-shaped structure.

In embodiments of the present disclosure, the iridium oxide may be located on or physically attached to at least a portion of the surface of the iridium-nickel oxide. The water electrolysis catalyst according to embodiments of the present disclosure may include at least one iridium-nickel oxide, and the iridium oxide may be located on, physically attached to, or located adjacent to at least a portion of the surface of the iridium-nickel oxide.

The water electrolysis catalyst according to embodiments of the present disclosure may not include the iridium oxide alone. In addition, the water electrolysis catalyst according to embodiments of the present disclosure may not include the iridium-nickel oxide alone.

In embodiments of the present disclosure, water electrolysis may include polymer electrolyte membrane (PEM) water electrolysis. PEM water electrolysis is an electrochemical reaction performed to separate water into hydrogen and oxygen by electricity supplied from outside and may have characteristics, such as fast hydrogen generation rate, high hydrogen purity, and flexible operation. In general, PEM water electrolysis may be performed in the form of a stack in which unit cells are stacked and assembled to meet a required hydrogen production amount, and a membrane electrode assembly may be located at the innermost part of the stack, without being limited thereto.

The water electrolysis catalyst according to embodiments of the present disclosure may exhibit improved durability under acidic conditions, i.e., actual water electrolysis conditions.

Another embodiment of the present disclosure relates to a preparation method of a water electrolysis catalyst including preparing a mixture including an iridium precursor, a nickel precursor, and cysteamine hydrochloride, drying the mixture, grinding the dried mixture, and firing a ground product.

In embodiments of the present disclosure, the iridium precursor may include at least one selected from the group consisting of iridium chloride (IrCl₃), iridium chloride hydrate (IrCl₃·xH₂O), potassium hexachloroiridate (K₂IrCl₆), potassium hexachloroiridate hydrate (K₂IrCl₆·xH₂O), and combinations thereof, and may include, for example, iridium chloride hydrate (IrCl₃·xH₂O), without being limited thereto.

In embodiments of the present disclosure, the nickel precursor may include at least one selected from the group consisting of nickel sulfate, nickel chloride, nickel bromide, nickel acetylacetonate, nickel cyclohexanebutyrate, nickel ethylhexanoate, nickel octanoate, and combinations thereof, and may include, for example, nickel chloride, without being limited thereto.

In embodiments of the present disclosure, cysteamine hydrochloride may be essentially required for formation of the iridium-nickel oxide including the hexagonal phase.

In the iridium precursor and the nickel precursor in embodiments of the present disclosure, the number of moles of iridium in the iridium precursor may be greater than the number of moles of nickel in the nickel precursor. Concretely, the iridium precursor and the nickel precursor may have a molar ratio of iridium:nickel which is 1.1:1 to 3:1, 1.3:1 to 3:1, 1.5:1 to 3:1, 1.7:1 to 3:1 or 2:1 to 3:1, and may be, for example, 2:1 to 3:1. When the molar ratio of iridium:nickel is about 1:1 or the number of moles of nickel is greater than the number of moles of iridium, impurities in the form of nickel oxide without iridium are synthesized, and therefore, the number of moles of iridium may be greater than the number of moles of nickel, or the molar ratio of iridium:nickel may be limited to the above range.

In embodiments of the present disclosure, the mixture may be prepared in an aqueous solution including sodium nitrate (NaNO₃), and therefore, may be characterized in that the mixture is not affected by a surrounding gas environment during heat treatment.

In embodiments of the present disclosure, the ground product may be fired at a temperature of 450° C. to 650° C., 500° C. to 650° C., or 550° C. to 650° C., and may be fired at a temperature of, for example, 550° C. to 650° C.

In embodiments of the present disclosure, in firing the ground product, the temperature of the ground product may be raised to a target temperature of 450° C. to 650° C. at a heating rate of 10° C./min, and may then maintain the target temperature for 30 minutes to 2 hours. Preferably, the target temperature may be 550° C. to 650° C., and the holding time may be about 1 hour.

Yet another embodiment of the present disclosure relates to a membrane electrode assembly (MEA) including a cathode, an anode, and an electrolyte membrane including a water electrolysis catalyst and interposed between the cathode and the anode.

In embodiments of the present disclosure, the MEA may include the polymer electrolyte membrane configured to conduct protons, and the cathode (i.e., an air electrode) and the anode (i.e., a fuel electrode) applied to both surfaces of the electrolyte membrane so that hydrogen and oxygen may react.

In embodiments of the present disclosure, water supplied to the anode is separated into oxygen, protons, and electrons, the protons may migrate to the cathode, which is a reduction electrode, through the membrane, and the electrons may move to the cathode through an external circuit and a power supply. At the cathode, the protons and the electrons may react together to produce hydrogen.

In embodiments of the present disclosure, the electrolyte membrane may include the water electrolysis catalyst which is substantially the same as the above-described water electrolysis catalyst, and a detailed description thereof will thus be omitted because it is considered to be unnecessary.

In embodiments of the present disclosure, at least one surface of the electrolyte membrane may be coated with the water electrolysis catalyst, without being limited thereto.

In embodiments of the present disclosure, porous transport layers (PTLs) or gas diffusion layers (GDLs), and in addition, gaskets may be respectively stacked on outer parts of the MEA where the anode and the cathode are located, but the embodiments of the present disclosure are not limited thereto. Separators or bipolar plates including flow fields through which reactants or products flow, or structures that may replace the flow fields, may be attached to the outer surfaces of the PTLs or the GDLs, but the embodiments of the present disclosure are not limited thereto.

In the case of polymer electrolyte membrane water electrolysis, corrosion of a GDL formed of carbon may occur because an anode maintains a high voltage of 1.7 V or more so as to perform water decomposition, and as a result, a PTL formed of titanium which is resistant to corrosion may be mainly stacked on the anode. A fuel cell is designed so that there is no corrosion reaction of carbon at an anode under normal operating conditions, and thus, a GDL may be stacked on the anode, but when a problem in hydrogen supply occurs or under instantaneous or continuous high voltage conditions, corrosion of such a carbon material may occur. The catalyst material of embodiments of the present disclosure has excellent catalytic activity and durability, and when the catalyst material is applied to a water electrolysis cell or a fuel cell, the above-mentioned corrosion or abnormal operation may be prevented.

The membrane electrode assembly in embodiments of the present disclosure may be a membrane electrode assembly for fuel cells.

Hereinafter, other embodiments of the present disclosure will be described in more detail through the following Preparation Examples and Test Examples. The following Preparation Examples and Test Examples serve merely to exemplarily describe embodiments of the present disclosure and are not intended to limit the scope and spirit of the invention.

### Preparation Example: Synthesis of Catalyst

A mixed solution prepared by dissolving 667 mg of an iridium precursor (IrCl₃xH₂O), 265 mg of a nickel precursor (NiCl₂6H₂O), 20 g of sodium nitrate (NaNO₃), and 500 mg of cysteamine hydrochloride in 300 mL of distilled water was stirred at 90° C. for 2 hours, and was then dried in an oven at 80° C.

Obtained dried powder was ground finely and then fired in a tube furnace. The temperature of the tube furnace was raised to a target firing temperature of 400° C., 500° C., 600° C., and 700° C. at 10° C./min, and then the tube furnace was maintained at the respective target firing temperatures for 1 hour. Thereafter, salts remaining in fired catalysts were removed using distilled water.

A control group was set to a catalyst fired without mixing a nickel precursor.

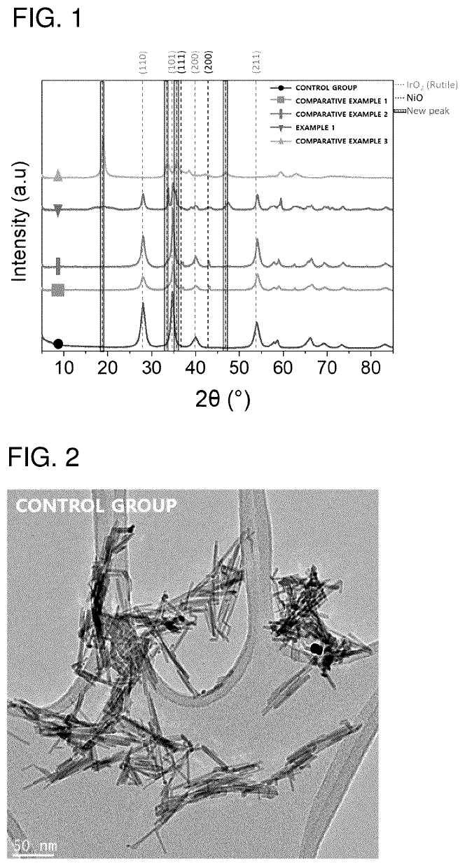

The crystal structures of the catalysts according to the control group, Example 1 (obtained at the firing temperature of 600° C.), Comparative Example 1 (obtained at the firing temperature of 400° C.), Comparative Example 2 (obtained at the firing temperature of 500° C.), and Comparative Example 3 (obtained at the firing temperature of 700° C.) were analyzed using peak areas depending on X-ray diffraction (XRD) analysis, and analysis results are shown in Table 1 and FIG. 1

TABLE 1

| | | Peak area | | | | |
|---|---|---|---|---|---|---|
| | Diffraction | | Comp. | Comp. | Ex- | Comp. |
| | angle | Control | example | example | ample | example |
| Category | (2θ) | group | 1 | 2 | 1 | 3 |
| Rutile | 28.0 | 24,309 | 8,188.5 | 16,428 | 5,852.6 | 0 |
| | 34.8 | 22,538 | 10,583 | 16,372 | 8,740.3 | 0 |
| | 40.0 | 6,523.1 | 2,464.1 | 5,168.1 | 2,427.0 | 0 |
| | 54.2 | 14,780 | 8,492.8 | 13,205 | 5,720.7 | 0 |
| Hexagonal | 19.0 | 0 | 0 | 0 | 6,395.0 | 15,000 |
| | 33.7 | 0 | 0 | 3,416.6 | 3,459.3 | 7,452.4 |
| | 35.8 | 0 | 0 | 3,745.3 | 5,398.1 | 11,253 |
| | 47 | 0 | 0 | 0 | 4,567.1 | 3,200.6 |

Referring to FIG. 1, it may be seen that rutile-phase iridium oxide (IrOₓ) was synthesized in the control group. In the case of low-temperature firing as in Comparative Example 1 where the firing temperature was 400° C. and Comparative Example 2 where the firing temperature was 500° C., it may be confirmed that rutile-phase iridium oxide (IrOₓ) [(110), (101), (200) and (211) crystal planes show high intensities] and nickel oxide (NiO) [(111) and (200) crystal planes show high intensities] were synthesized.

Meanwhile, in the case of Example 1 where the firing temperature was 600° C., it may be confirmed that hexagonal-phase iridium-nickel oxide (Ir₂NiOₓ) indicating new peaks started to be synthesized at positions of diffraction angles 2θ of 19.0°, 33.7°, 35.8°, and 47°, and the existing rutile phase started to disappear.

Furthermore, in the case of Comparative Example 3 where the firing temperature was 700° C., it may be confirmed that there was no rutile-phase iridium oxide (IrOₓ) at all and iridium-nickel oxide (Ir₂NiOₓ) with a completely hexagonal crystal system was synthesized.

### Test Example 1. Evaluation of Appearance of Catalyst Particles

Results of observation of catalyst particles of the control group, Comparative Example 2, Example 1, and Comparative Example 3 using a transmission electron microscope (TEM) are shown in FIGS. 2 to 5.

Referring to FIG. 2, it may be confirmed that, in the control group without adding nickel, IrO₂ in the form of thin nanoneedles was formed.

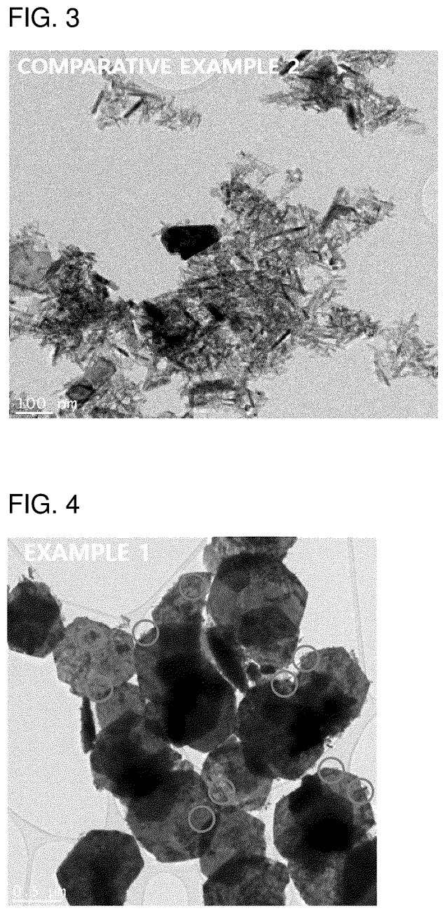

Referring to FIG. 3, it may be confirmed that, in Comparative Example 2 where the firing temperature was 500° C., IrO₂ in the form of thin nanoneedles was formed like in the control group, and this is consistent with detection of the rutile-phase IrOₓ peaks in the XRD pattern of FIG. 1.

Referring to FIG. 4, it may be confirmed that, in Example 1 where the firing temperature was 600° C., the hexagonal phase, i.e., hexagonal platelet-shaped structures, started to be formed, and this is consistent with start of creation of the hexagonal-phase peaks in the XRD pattern of FIG. 1. More specifically, in Example 1, it may be confirmed that IrO₂ (indicated by a yellow circle) in the form of nanoneedles remained on the surfaces of the hexagonal platelet-shaped structures and indicated that the hexagonal phase and the rutile phase exist simultaneously.

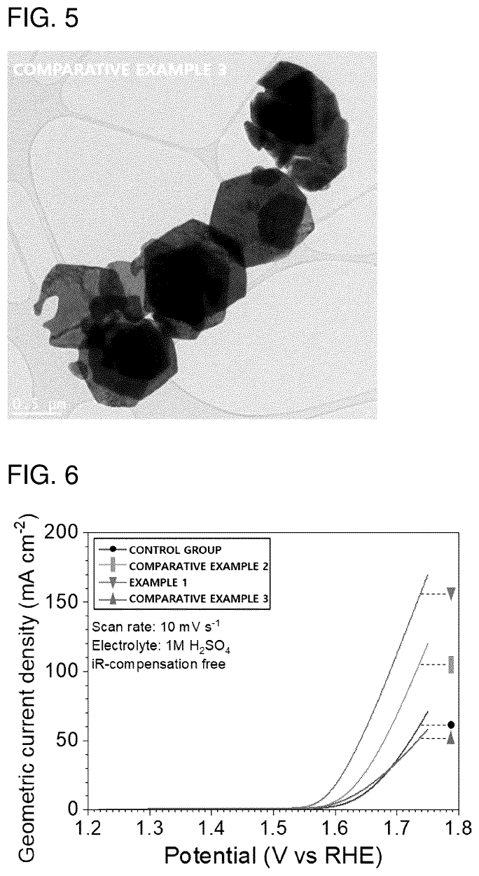

Referring to FIG. 5, it may be confirmed that, in Comparative Example 3 where the firing temperature was 700° C., hexagonal platelet-shaped structures appeared more clearly, and IrO₂ in the form of nanoneedles was no longer observed. This is consistent with the result that no rutile peak was observed and only new peaks, i.e., the hexagonal-phase peaks, were observed in the XRD pattern of FIG. 1.

### Test Example 2. Evaluation of Catalytic Activity Using Three Electrode System

A three electrode system was used to evaluate activities of the catalysts synthesized in Preparation Example by using 1 M sulfuric acid (H₂SO₄) solution as an electrolyte and applying the catalysts to a glassy carbon rotating disk electrode (RDE). A Pt coil was used as a counter electrode, an RHE electrode was used as a reference electrode, and the current densities of the catalysts were measured at voltages from 1.2 V to 1.75 V and a scan rate of 10 mV/s using linear sweep voltammetry (LSV). Measurement results are shown in FIG. 6.

Referring to FIG. 6, it may be confirmed that performances of the catalysts to which nickel was added were superior to that of the catalyst in the control group to which nickel was not added. Concretely, it may be confirmed that the performance of the catalyst of Example 1 was significantly superior to that of the catalyst of Comparative Example 2, and the performance of the catalyst in Comparative Example 3 which was completely changed to the hexagonal phase rapidly decreased.

That is, the catalyst of Example 1, which was at the moment when phase change from the rutile phase to the hexagonal phase occurs, showed the best performance.

### Test Example 3. Evaluation of Water Electrolysis Performance of Membrane Electrode Assembly

The performances of the catalysts were evaluated under conditions of membrane electrode assembly (MEA), which is an actual water electrolysis device.

A control group was set to a membrane electrode assembly using a catalyst synthesized using the same method as in the above-described Preparation Example without using a nickel precursor and cysteamine hydrochloride.

The manufacturing method and cell test method of each of the membrane electrode assemblies including the respective catalysts are as follows.

In order to evaluate the membrane electrode assembly, the catalyst synthesized in Preparation Example was coated on a membrane, and Nafion 212 was used as the membrane. The catalysts were coated directly on the membrane by spraying with an airbrush (Infinity, Harder & Steenbeck). Ir₂NiOₓ was coated at 1.0 mg catalyst/cm² as an oxidation electrode catalyst, and 40 wt % Pt/C was coated at 0.1 mg Pt/cm² as a reduction electrode catalyst. As diffusion layers, Ti felt was used on an oxidation electrode, and carbon paper was used on a reduction electrode. When the membrane electrode assembly was assembled, hot pressing was not used, and a pressure of 80 kgf cm was applied when the membrane electrode assembly is fastened into a single cell. Distilled water was flowed to the oxidation electrode at 10 mL/min. The temperature of the cell and distilled water was maintained at 80° C.

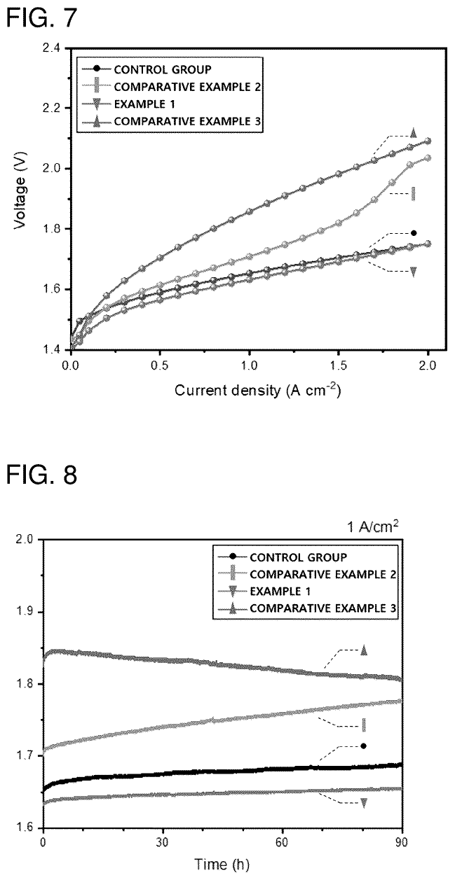

Activity of the catalyst was evaluated by measuring the average voltage of the catalyst for 3 minutes at a specific current density between 0 A/cm² and 2 A/cm², and results are shown in FIG. 7.

Referring to FIG. 7, it may be confirmed that the membrane electrode assembly including the catalyst of Example 1, in which the hexagonal phase starts to be formed exhibits the best activity, and this is consistent with the best performance of the catalyst of Example 1 in the three electrode system confirmed in Test Example 2.

In addition, the durabilities of the membrane electrode assemblies were evaluated by measuring changes in voltage for 90 hours at a current density of 1 A/cm², and results are shown in FIG. 8.

Referring to FIG. 8, it may be confirmed that the durability of the membrane electrode assembly including the catalyst of Example 1 fired at 600° C. is the best, compared to the control group.

As is apparent from the above description, a water electrolysis catalyst including iridium-nickel oxide according to embodiments of the present disclosure may have excellent activity and durability and reduced iridium usage, compared to a conventional catalyst including iridium oxide, thereby being very useful.

A preparation method of the catalyst according to embodiments of the present disclosure may implement the nanoparticle structure of the catalyst, which is difficult to implement using the molten salt synthesis method, while finely adjusting the nanoparticle structure, and is advantageous in preparing the catalyst including iridium oxide with a nanoneedle-shaped structure and iridium-nickel oxide with a hexagonal platelet-shaped structure according to embodiments of the present disclosure.

The effects of embodiments of the present disclosure are not limited to the above-mentioned effects. The effects of embodiments of the present disclosure should be understood to include all effects that may be inferred from the above description.

Embodiments of the invention have been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A water electrolysis catalyst comprising:
iridium oxide comprising a rutile phase; and
iridium-nickel oxide comprising a hexagonal phase.

2. The water electrolysis catalyst of claim 1, wherein the iridium oxide comprises a peak for at least one crystal plane selected from the group consisting of a (110), (101), (200), and (211) crystal plane, based on an analysis by X-ray diffraction (XRD).

3. The water electrolysis catalyst of claim 1, wherein the iridium-nickel oxide comprises a peak for at least one diffraction angle 2θ selected from the group consisting of 18° to 20°, 33.0° to 34.5°, 35.0° to 37.0°, and 46° to 48°, based on an analysis by X-ray diffraction (XRD).

4. The water electrolysis catalyst of claim 1, wherein:
the iridium oxide has a nanoneedle-shaped structure; and
the iridium-nickel oxide has a hexagonal platelet-shaped structure.

5. The water electrolysis catalyst of claim 4, wherein the iridium oxide having the nanoneedle-shaped structure is located on a portion of a surface of the iridium-nickel oxide having the hexagonal platelet-shaped structure.

6. The water electrolysis catalyst of claim 4, wherein the iridium oxide having the nanoneedle-shaped structure is physically attached to a portion of a surface of the iridium-nickel oxide having the hexagonal platelet-shaped structure.

7. A method of preparing a water electrolysis catalyst, the method comprising:
preparing a mixture comprising an iridium precursor, a nickel precursor, and cysteamine hydrochloride;
drying the mixture;
grinding the dried mixture; and
firing a ground product; and
wherein the water electrolysis catalyst comprises:
iridium oxide comprising a rutile phase; and
iridium-nickel oxide comprising a hexagonal phase.

8. The method of claim 7, wherein the iridium precursor comprises at least one composition selected from the group consisting of iridium chloride (IrCl₃), iridium chloride hydrate (IrCl₃·xH₂O), potassium hexachloroiridate (K₂IrCl₆), potassium hexachloroiridate hydrate (K₂IrCl₆·xH₂O), and combinations thereof.

9. The method of claim 7, wherein the nickel precursor comprises at least one composition selected from the group consisting of nickel sulfate, nickel chloride, nickel bromide, nickel acetylacetonate, nickel cyclohexanebutyrate, nickel ethylhexanoate, nickel octanoate, and combinations thereof.

10. The method of claim 7, wherein the iridium precursor and the nickel precursor are configured such that a number of moles of iridium is greater than a number of moles of nickel.

11. The method of claim 7, wherein the iridium precursor and the nickel precursor are configured such that a molar ratio of iridium:nickel is 1.1:1 to 3:1.

12. The method of claim 7, wherein preparing the mixture is performed in an aqueous solution comprising sodium nitrate (NaNO₃).

13. The method of claim 7, wherein firing the ground product is performed at a temperature of 450° C. to 650° C.

14. The method of claim 7, wherein, in firing the ground product, a temperature of the ground product is raised to a target temperature of 450° C. to 650° C. at a heating rate of 10° C./min, and then the target temperature is maintained for 30 minutes to 2 hours.

15. A membrane electrode assembly comprising:
a cathode;
an anode; and
an electrolyte membrane interposed between the cathode and the anode and comprising a water electrolysis catalyst, wherein the water electrolysis catalyst comprises iridium oxide comprising a rutile phase and iridium-nickel oxide comprising a hexagonal phase.

16. The membrane electrode assembly of claim 15, wherein the iridium oxide comprises a peak for at least one crystal plane selected from the group consisting of a (110), (101), (200), and (211) crystal plane, based on an analysis by X-ray diffraction (XRD).

17. The membrane electrode assembly of claim 15, wherein the iridium-nickel oxide comprises a peak for at least one diffraction angle 2θ selected from the group consisting of 18° to 20°, 33.0° to 34.5°, 35.0° to 37.0°, and 46° to 48°, based on an analysis by X-ray diffraction (XRD).

18. The membrane electrode assembly of claim 15, wherein:
the iridium oxide has a nanoneedle-shaped structure; and
the iridium-nickel oxide has a hexagonal platelet-shaped structure.

19. The membrane electrode assembly of claim 18, wherein the iridium oxide having the nanoneedle-shaped structure is located on a portion of a surface of the iridium-nickel oxide having the hexagonal platelet-shaped structure.

20. The membrane electrode assembly of claim 18, wherein the iridium oxide having the nanoneedle-shaped structure is physically attached to a portion of a surface of the iridium-nickel oxide having the hexagonal platelet-shaped structure.
